(19) United States
(12) Patent Application Publication
(10) Pub. No.: US 2025/0353674 A1
(43) Pub. Date: Nov. 20, 2025

(54) STACKER CRANE AND WAREHOUSING SYSTEM

(71) Applicant: GUANGDONG LEAD INTELLIGENT LOGISTICS TECHNOLOGY CO.,LTD., Zhuhai (CN)

(72) Inventors: Dongdong MAO, Zhuhai (CN); Lichuan TIAN, Zhuhai (CN); Zhonghui WANG, Zhuhai (CN)

(21) Appl. No.: 19/286,558

(22) Filed: Jul. 31, 2025

Related U.S. Application Data
(63) Continuation of application No. PCT/CN2024/102571, filed on Jun. 28, 2024.

(30) Foreign Application Priority Data
Sep. 27, 2023 (CN) 202311262420.2
Sep. 27, 2023 (CN) 202322637757.9

(51) Int. Cl. B65G 1/04; B66F 9/07; B66F 9/075

(52) U.S. Cl. CPC B65G 1/0407; B66F 9/07; B66F 9/0755

(57) ABSTRACT

A stacker crane and a warehousing system are provided. The stacker crane includes a frame assembly, a loading platform and a mobile assembly. The loading platform is movably arranged in the frame assembly. The mobile assembly includes a bracket, a movable plate and a driving member. The bracket is arranged on the loading platform, and the movable plate is movably connected to the bracket through the driving member. A door connecting structure is arranged on the movable plate, and the driving member drives the movable plate to move. The warehousing system includes the stacker crane as described.

### CROSS-REFERENCE TO RELATED APPLICATIONS

The present application is a U.S. Continuation of International Application PCT/CN2024/102571 filed on Jun. 28, 2024, which claims priority to Chinese patent applications 202311262420.2 and 202322637757.9, and both entitled “STACKER CRANE AND WAREHOUSING SYSTEM,” which were filed with China National Intellectual Property Administration on Sep. 27, 2023, the content of the aforementioned applications is incorporated herein by reference in its entirety.

### TECHNICAL FIELD

The present disclosure relates to the field of mobile structures, in particular, to a stacker crane and a warehousing system.

### BACKGROUND

During the production and circulation process of some products, there is a need to store the products in a facility with facility doors to ensure the airtightness of the products.

In the prior art, power equipment is usually added to the facility to open and close the facility doors. When the facility doors are opened, a stacker crane may be used to move the products within the facility. However, the installation of the power equipment not only occupies a significant amount of space but also increases the complexity of opening and closing the facility doors.

Therefore, how to improve the efficiency of the structural cooperation between the stacker crane and the facility is an urgent problem to be solved.

### SUMMARY

An objective of the embodiments of the present disclosure is to provide a new technical solution for a stacker crane and a warehousing system.

According to a first aspect of the embodiments of the present disclosure, an exemplary stacker crane is provided, including: a frame assembly; a loading platform, the loading platform movably arranged in the frame assembly; a mobile assembly, the mobile assembly including a bracket, a movable plate and a driving member, the bracket arranged on the loading platform, and the movable plate movably connected to the bracket through the driving member, where the driving member drives the movable plate to move; a door connecting structure arranged on the movable plate.

In some embodiments, the driving member includes a first driving member and a connecting member, the first driving member is arranged on the bracket, and an output end of the first driving member is connected to the movable plate through the connecting member. The first driving member is configured to drive the connecting member and the movable plate to move together along a first direction.

In some embodiments, a first sliding rail is arranged on the bracket. A first sliding block is arranged on the connecting member. The first sliding block is in sliding fit with the first sliding rail. Alternatively, the first sliding block is arranged on the bracket. The first sliding rail is arranged on the connecting member. The first sliding block is in sliding fit with the first sliding rail.

In some embodiments, the driving member includes a second driving member. The second driving member is arranged on the connecting member, and an output end of the second driving member is connected to the movable plate. The second driving member is configured to drive the movable plate to move along a second direction. The second direction is perpendicular to the first direction.

In some embodiments, a second sliding block is arranged on the connecting member. A second sliding rail is arranged on the movable plate. The second sliding rail is in sliding fit with the second sliding block. Alternatively, the second sliding rail is arranged on the connecting member. The second sliding block is arranged on the movable plate. The second sliding rail is in sliding fit with the second sliding block.

In some embodiments, the stacker crane further includes two distance-measuring sensors arranged on the movable plate. The two distance-measuring sensors are arranged oppositely.

In some embodiments, the door connecting structure includes hooks. The door connecting structure further includes a guide shaft and an elastic member. The movable plate includes a guide hole. The guide shaft is movably arranged in the guide hole. At least one of the hooks is connected to the guide shaft. The elastic member abuts between the movable plate and the hook.

In some embodiments, the door connecting structure further includes an anti-drop cap, and circumferential dimensions of the anti-drop cap and the hook are greater than an aperture of the guide hole. The hook is connected to a first end of the guide shaft. The anti-drop cap is connected to a second end of the guide shaft. The hook and the anti-drop cap are located on two sides of the movable plate, respectively.

In some embodiments, the door connecting structure includes a pressing block. The driving member includes a third driving member. The third driving member is configured to drive the pressing block to move in a direction toward the hook.

According to a second aspect of the embodiments of the present disclosure, an exemplary warehousing system is provided, including a facility and the stacker crane according to the first aspect. The facility includes a door body. The door connecting structure is connected to the door body and may switch between an open-door position and a closed-door position.

In some embodiments, the warehousing system further includes a loading platform lifting mechanism, a pulley assembly and a traveling mechanism. The loading platform lifting mechanism and the traveling mechanism are installed on the frame assembly. The mobile assembly is installed on the loading platform. The loading platform is connected to the loading platform lifting mechanism through a rope via the pulley assembly.

In some embodiments, the driving member includes a first driving member and a connecting member. The first driving member is arranged on the bracket. An output end of the first driving member is connected to the movable plate through the connecting member. The first driving member is configured to drive the connecting member and the movable plate to move together along a first direction.

In some embodiments, the stacker crane further includes a first sliding rail arranged on the bracket and a first sliding block arranged on the connecting member. The first sliding block is in sliding fit with the first sliding rail, Alternatively, the first sliding block is arranged on the bracket, and the first sliding rail is arranged on the connecting member. The first sliding block is in sliding fit with the first sliding rail.

In some embodiments, the driving member includes a second driving member. The second driving member is arranged on the connecting member. An output end of the second driving member is connected to the movable plate. The second driving member is configured to drive the movable plate to move along a second direction. The second direction is perpendicular to the first direction.

In some embodiments, the stacker crane further includes a second sliding block arranged on the connecting member and a second sliding rail arranged on the movable plate. The second sliding rail is in sliding fit with the second sliding block. Alternatively, the second sliding rail is arranged on the connecting member, and the second sliding block is arranged on the movable plate. The second sliding rail is in sliding fit with the second sliding block.

In some embodiments, the stacker crane further includes two distance-measuring sensors arranged on the movable plate. The two distance-measuring sensors are arranged oppositely.

In some embodiments, the door connecting structure includes hooks. The door connecting structure further includes a guide shaft, and an elastic member. The movable plate includes a guide hole. The guide shaft is movably arranged in the guide hole. At least one of the hooks is connected to the guide shaft, and the elastic member abuts between the movable plate and the hook.

In some embodiments, the door connecting structure includes an anti-drop cap, and circumferential dimensions of the anti-drop cap and the at least one of the hooks are greater than an aperture of the guide hole. The at least one of the hooks is connected to a first end of the guide shaft. The anti-drop cap is connected to a second end of the guide shaft. The at least one of the hooks and the anti-drop cap are located on two sides of the movable plate, respectively.

In some embodiments, the door connecting structure includes a pressing block. The driving member includes a third driving member. The third driving member is configured to drive the pressing block to move in a direction toward the at least one of the hooks.

In some embodiments, the stacker crane further includes a loading platform lifting mechanism, a pulley assembly and a traveling mechanism. The loading platform lifting mechanism and the traveling mechanism are installed on the frame assembly. The mobile assembly is installed on the loading platform. The loading platform is connected to the loading platform lifting mechanism through a rope via the pulley assembly.

A technical effect of the present disclosure lies in the following.

The embodiments of the present disclosure provide a stacker crane which includes a frame assembly; a loading platform movably arranged in the frame assembly; a mobile assembly including a bracket, a movable plate and a driving member. The bracket is arranged on the loading platform, and the movable plate is movably connected to the bracket through the driving member. A door connecting structure is arranged on the movable plate, and the driving member drives the movable plate to move, so that the door connecting structure switches between the open-door position and the closed-door position, which improves the convenience of opening and closing the door by the movable plate and ensures the efficiency of the structural cooperation between the stacker crane and the facility.

Through the detailed description of the exemplary embodiments of the present disclosure with reference to the accompanying drawings, other features and advantages of the present disclosure will become apparent.

### BRIEF DESCRIPTION OF THE DRAWINGS

The accompanying drawings, which are incorporated in and constitute part of this specification, illustrate the embodiments of the present disclosure and, together with the description thereof, serve to explain the principles of the present disclosure.

FIG. 1 is an overall schematic diagram of a stacker crane provided by an embodiment of the present disclosure;

FIG. 2 is a schematic diagram of a bracket of a stacker crane provided by an embodiment of the present disclosure;

FIG. 3 is a partial schematic diagram of a stacker crane provided by an embodiment of the present disclosure;

FIG. 4 is a sectional view taken along the line A-A in FIG. 3;

FIG. 5 is a top view of a bracket of a stacker crane provided by an embodiment of the present disclosure;

FIG. 6 is a first schematic diagram of a driving member of a stacker crane provided by an embodiment of the present disclosure;

FIG. 7 is a first schematic diagram of a movable plate of a stacker crane provided by an embodiment of the present disclosure;

FIG. 8 is a sectional view taken along the line B-B in FIG. 7;

FIG. 9 is a partially enlarged view from FIG. 8;

FIG. 10 is a second schematic diagram of a driving member of a stacker crane provided by an embodiment of the present disclosure;

FIG. 11 is a schematic diagram illustrating the cooperation between a movable plate and a driving member of a stacker crane provided by an embodiment of the present disclosure;

FIG. 12 is a side view of a mobile assembly of a stacker crane provided by an embodiment of the present disclosure;

FIG. 13 is a front view of a mobile assembly of a stacker crane provided by an embodiment of the present disclosure;

FIG. 14 is a sectional view taken along the line C-C in FIG. 13;

FIG. 15 is a third schematic diagram of a driving member of a stacker crane provided by an embodiment of the present disclosure;

FIG. 16 is a fourth schematic diagram of a driving member of a stacker crane provided by an embodiment of the present disclosure;

FIG. 17 is a schematic diagram of a connecting member of a stacker crane provided by an embodiment of the present disclosure;

FIG. 18 is a second schematic diagram of a movable plate of a stacker crane provided by an embodiment of the present disclosure;

FIG. 19 is a sectional view of a movable plate of a stacker crane provided by an embodiment of the present disclosure;

FIG. 20 is a front view of the connection between a movable plate and a door body of a stacker crane provided by an embodiment of the present disclosure;

FIG. 21 is a top view of the connection between a movable plate and a door body of a stacker crane provided by an embodiment of the present disclosure;

FIG. 22 is a schematic diagram of a door body; and

FIG. 23 is schematic side view of the stacker crane and the shelf according to an embodiment of the present disclosure.

Reference numerals in the accompanying drawings:
1. Frame assembly; 2. Loading platform; 3. Mobile assembly; 31. Bracket; 311. First sliding rail; 32. Movable plate; 321. Second sliding rail; 322. Distance-measuring sensor; 323. Guide hole; 33. Driving member; 331. First driving member; 332. Connecting member; 3321. First sliding block; 3322. Second sliding block; 333. Second driving member; 334. Third driving member; 335. Synchronous belt; 34. Door connecting structure; 341. Hook; 342. Guide shaft; 343. Elastic member; 344. Anti-drop cap; 345. Pressing block; 4. Loading platform lifting mechanism; 5. Pulley assembly; 6. Traveling mechanism; 10. Stacker crane; 100. Shelf; 101. Door body; 102. Connecting shaft.

### DETAILED DESCRIPTION

Various exemplary embodiments of the present disclosure will now be described in detail with reference to the accompanying drawings. It should be noted that unless otherwise specifically stated, the relative arrangements of components and steps, numerical expressions and numerical values set forth in these embodiments do not limit the scope of the present disclosure.

The embodiments of the present disclosure will be described in detail below, and examples of the embodiments are shown in the accompanying drawings. The embodiments described below by referring to the accompanying drawings are exemplary, and are only used to explain the present disclosure, and should not be construed as limiting the present disclosure. Based on the embodiments in the present disclosure, all other embodiments obtained by a person having ordinary skill in the art without creative efforts shall fall within the scope of the present disclosure.

The terms “first” and “second” in the specification and claims of the present disclosure may explicitly or implicitly include one or more of these features. In the description of the present disclosure, unless otherwise specified, “a plurality of/multiple” means two or more. In addition, “and/or” in the specification and claims indicates at least one of the connected objects, and the sign “/” generally indicates an “alternative/or” relationship between the associated objects.

In the description of the present disclosure, it should be understood that the terms “center,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” etc. indicate the orientations or positional relationships based on the orientations or positional relationships shown in the accompanying drawings, which are only for the convenience of describing the present disclosure and simplifying the description, and do not indicate or imply that the referred device or element must have a specific orientation, be constructed and operated in a specific orientation, and thus, should not be construed as limiting the present disclosure.

In the description of the present disclosure, it should be noted that unless otherwise clearly specified or limited, the terms “installation,” “connection” and “connection” should be understood in a broad sense, for example, it may be a fixed connection, a detachable connection, or an integral connection; it may be a mechanical connection or an electrical connection; it may be a direct connection, or an indirect connection through an intermediate medium, and it may be the internal communication between two elements. For a person having ordinary skill in the art, the specific meanings of the above terms in the present disclosure may be understood according to specific situations.

It should be noted that similar reference numerals and letters in the following accompanying drawings represent similar items. Therefore, once an item is defined in one accompanying drawing, it does not need to be further discussed in subsequent accompanying drawings.

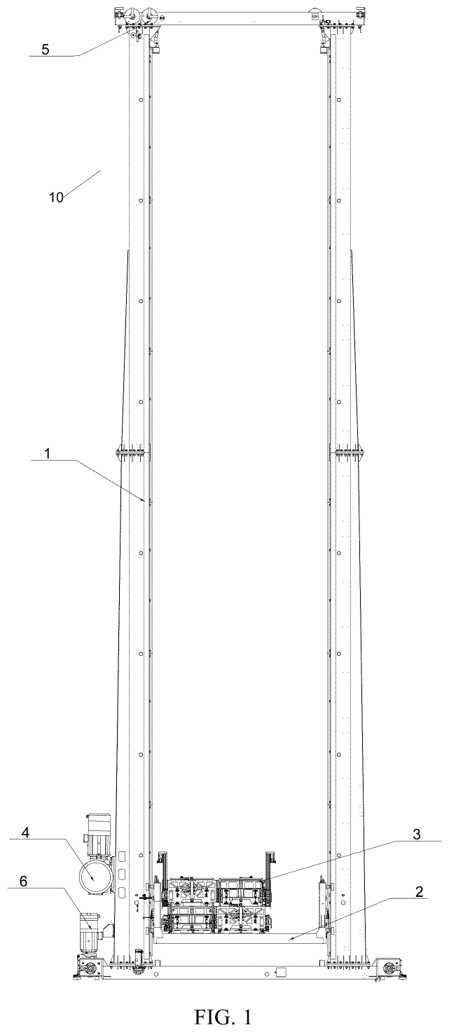

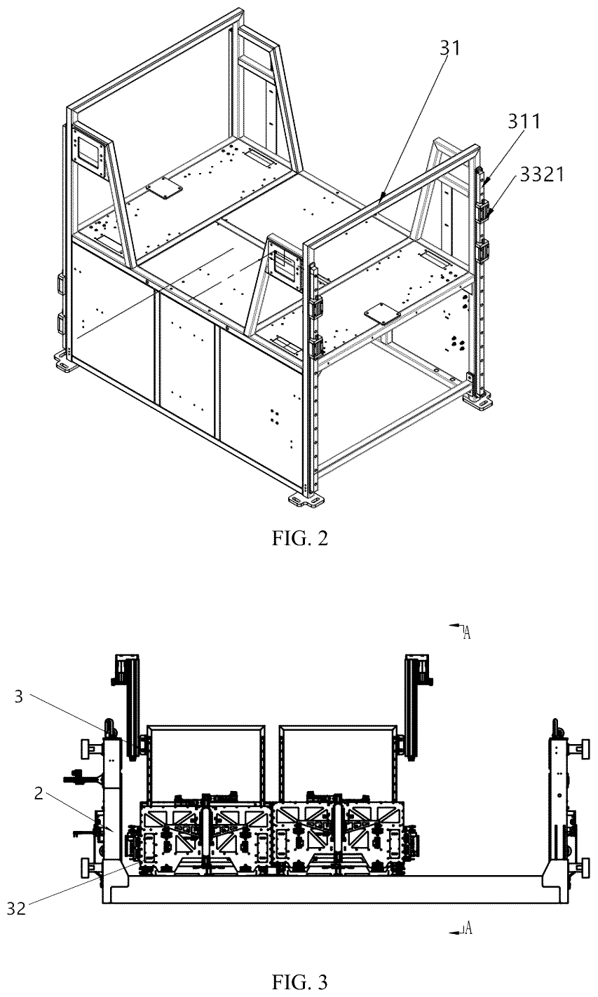

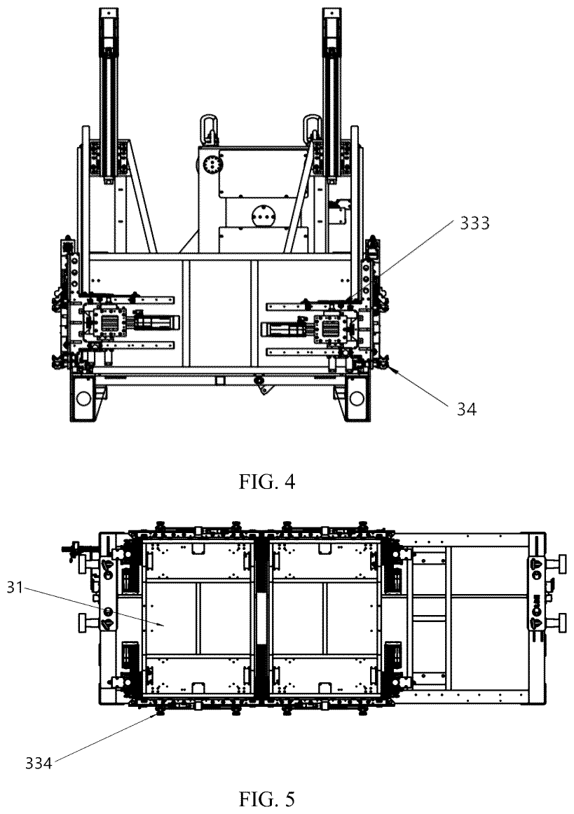

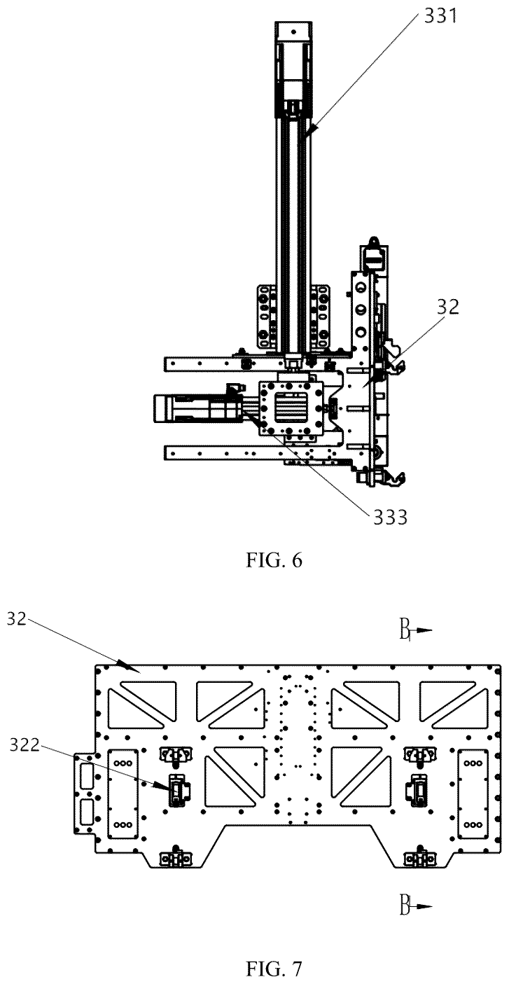

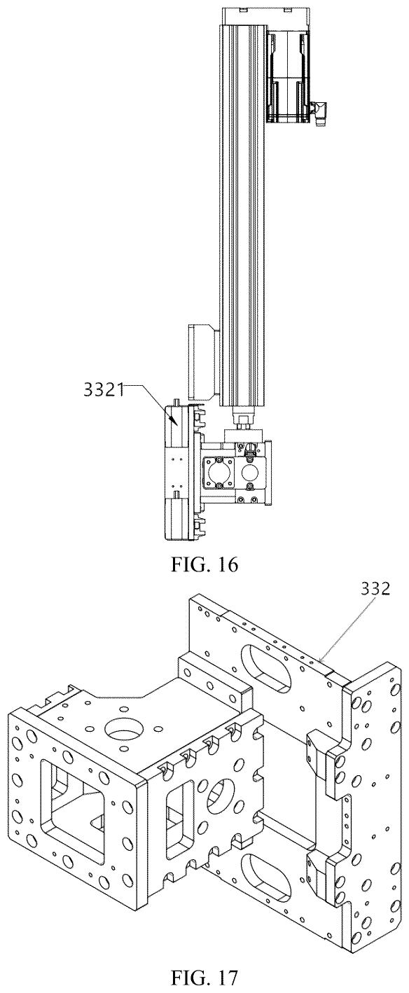

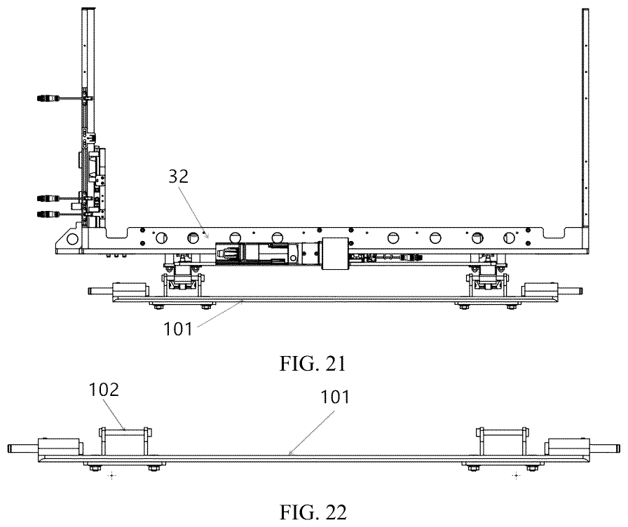

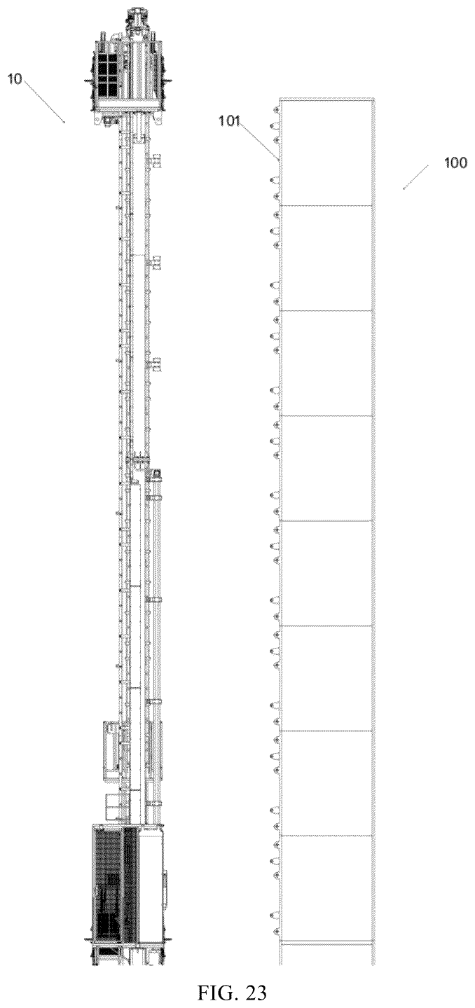

With reference to FIGS. 1 to 22, an embodiment of the present disclosure provides an exemplary stacker crane, and the stacker crane includes:
a frame assembly 1;
a loading platform 2, the loading platform 2 movably arranged in the frame assembly 1;
a mobile assembly 3, the mobile assembly 3 including a bracket 31, a movable plate 32 and a driving member 33, the bracket 31 arranged on the loading platform 2, and the movable plate 32 movably connected to the bracket 31 through the driving member 33;
a door connecting structure 34 arranged on the movable plate 32, where the driving member 33 drives the movable plate 32 to move, so that the door connecting structure 34 switches between the open-door position and the closed-door position.

When the driving member 33 drives the movable plate 32 to move until the door connecting structure 34 is connected to a door body 101 of a facility, the movable plate 32 and the door body 101 may move together, so that the door body 101 switches between an open position and a closed position. For example, when the door connecting structure 34 is in the open-door position, the movable plate 32 and the door body 101 move together and may drive the door body 101 to open, so that the door body 101 is in the open position. When the door connecting structure 34 is in the closed-door position, the movable plate 32 and the door body 101 move together and may drive the door body 101 to close, so that the door body 101 is in the closed position.

The facility with the door body 101 may be used to store products such as batteries or circuit boards. For example, the facility may be a shelf 100 for storing different products, such as batteries, circuit boards or the like. Door body 101 seals the space inside the facility to ensure the airtightness of the products during storage.

In one embodiment, the bracket 31 is used to store batteries. The transfer of the batteries may be achieved by the movement of the mobile assembly 3 on the loading platform 2, whereas the movable plate 32 is movably connected to the bracket 31 through the driving member 33, so that the closure of the bracket 31 may be achieved.

With reference to FIG. 1, the stacker crane includes a loading platform lifting mechanism 4, a pulley assembly 5 and a traveling mechanism 6. The loading platform lifting mechanism 4 and the traveling mechanism 6 are installed on the frame assembly 1, the mobile assembly 3 is installed on the loading platform 2, and the loading platform 2 is connected to the loading platform lifting mechanism 4 through a rope via the pulley assembly 5. The loading platform lifting mechanism 4 may flexibly control the lifting of the loading platform 2 and the mobile assembly 3, and the traveling mechanism 6 may drive the entire frame assembly 1 to move, that is, the movement of the loading platform 2 and the mobile assembly 3 is achieved.

Under the first condition where the driving member 33 drives the movable plate 32 to move. The movable plate 32 may move to the position where the door connecting structure 34 is connected to the door body 101. At the same time, the loading platform lifting mechanism 4 and the traveling mechanism 6 may drive the movable plate 32 and the door body 101 to move together, allowing the door body 101 to switch between the open position and the closed position. This eliminates the need to provide a structure for opening and closing the door of the facility, improving the convenience of opening and closing the door by the movable plate and ensuring the efficiency of the structural cooperation between the stacker crane and the facility.

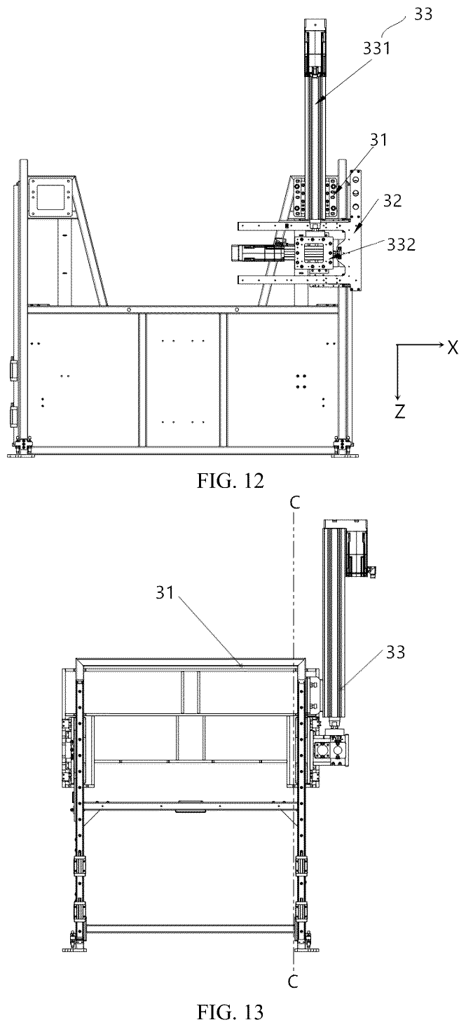

With reference to FIGS. 12 to 14, the driving member 33 includes a first driving member 331 and a connecting member 332. The first driving member 331 is arranged on the bracket 31, and an output end of the first driving member 331 is connected to the movable plate 32 through the connecting member 332.

The first driving member 331 is configured to drive the connecting member 332 and the movable plate 32 to move together along a first direction.

The first direction may be the Z direction in FIG. 12 (including the positive Z direction and the negative Z direction). When the door connecting structure 34 needs to move along the first direction to be connected to the door body 101 of the facility, the first driving member 331 may drive the connecting member 332 and the movable plate 32 to move together along the first direction. For example, the first driving member 331, in the form of a motor or a pneumatic cylinder, may drive the movable plate 32 to move along the first direction. This facilitates the connection between the door connecting structure 34 and the door body 101 by means of the movable plate 32 and facilitates the opening and closing of the door body 101.

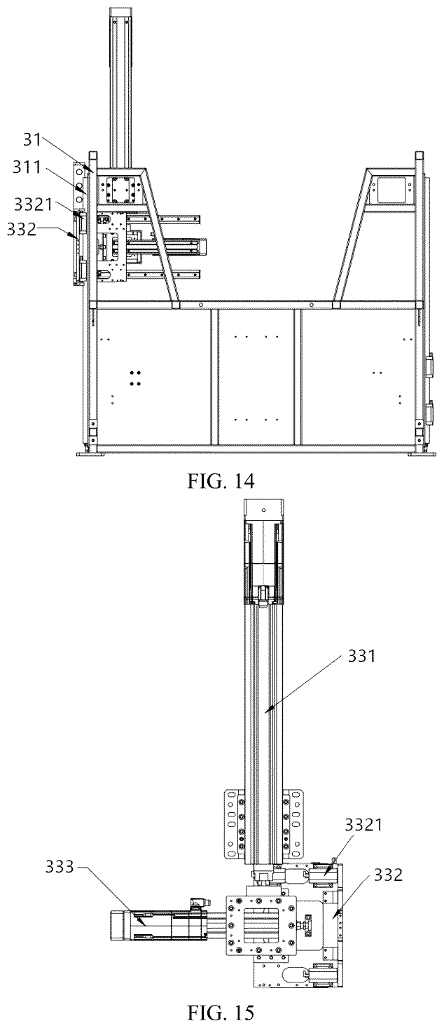

With reference to FIG. 14, a first sliding rail 311 is arranged on the bracket 31, a first sliding block 3321 is arranged on the connecting member 332, and the first sliding block 3321 is in sliding fit with the first sliding rail 311.

When the output end of the first driving member 331 is connected to the movable plate 32 through the connecting member 332, the connection between the connecting member 332 and the movable plate 32 may be a direct connection or an indirect connection.

When the first driving member 331 drives the connecting member 332 to move along the first direction, because the first sliding block 3321 is in sliding fit with the first sliding rail 311, that is, the first sliding rail 311 may provide guidance for the movement of the connecting member 332, the positional accuracy of the connecting member 332 and the movable plate 32 when they move together is ensured.

In another embodiment, a first sliding block 3321 may be arranged on the bracket 31. A first sliding rail 311 may be arranged on the connecting member 332. The first sliding block 3321 is in sliding fit with the first sliding rail 311. Similarly, the sliding direction of the first sliding rail 311 may be guided by the first sliding block 3321, ensuring the consistency of the movement direction of the connecting member 332 and the movable plate 32.

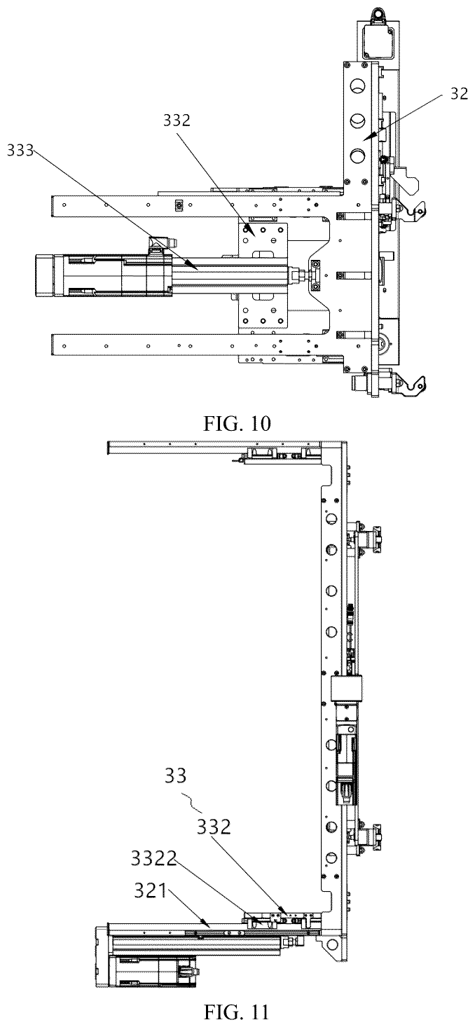

With reference to FIGS. 10 to 12, the driving member 33 includes a second driving member 333. The second driving member 333 is arranged on the connecting member 332. An output end of the second driving member 333 is connected to the movable plate 32.

The second driving member 333 is configured to drive the movable plate 32 to move along a second direction, and the second direction is perpendicular to the first direction.

Specifically, the second direction may be the X direction in FIG. 12 (including the positive X direction and the negative X direction). When the door connecting structure 34 needs to move along the second direction to be connected to the door body 101 of the facility, the second driving member 333 may directly drive the movable plate 32 to move along the second direction. For example, the second driving member 333, in the form of a motor or a pneumatic cylinder, may drive the movable plate 32 to move along the second direction. This facilitates the connection between the door connecting structure 34 and the door body 101 by means of the movable plate 32 and facilitates the opening and closing of the door body 101.

Furthermore, the second driving member 333 achieves the indirect connection between the connecting member 332 and the movable plate 32. The movable plate 32 may move along the second direction relative to the connecting member 332. Through the cooperation of the first driving member 331 and the second driving member 333, the flexible movement of the movable plate 32 in the first direction and the second direction may be achieved.

With reference to FIG. 11, a second sliding block 3322 may be arranged on the connecting member 332, a second sliding rail 321 may be arranged on the movable plate 32. The second sliding rail 321 is in sliding fit with the second sliding block 3322.

When the second driving member 333 drives the movable plate 32 to move along the second direction, because the second sliding rail 321 is in sliding fit with the second sliding block 3322. The second sliding block 3322 may provide guidance for the movement of the second sliding rail 321, ensuring the positional accuracy of the movable plate 32 when it moves.

In another embodiment, a second sliding rail 321 is arranged on the connecting member 332. A second sliding block 3322 is arranged on the movable plate 32. The second sliding rail 321 is in sliding fit with the second sliding block 3322. Similarly, the sliding direction of the second sliding block 3322 may be guided by the second sliding rail 321, ensuring the movement direction of the movable plate 32.

With reference to FIG. 7, two distance-measuring sensors 322 are arranged on the movable plate 32. The two distance-measuring sensors 322 are arranged oppositely facing the other. The two distance-measuring sensors 322 may be used to measure a horizontal degree of a door-opening object of the movable plate 32.

The distance-measuring sensor 322 may be a photoelectric sensor. Under a condition that the door body 101 connected to the movable plate 32 tilts relative to the horizontal direction, the intensity of the photoelectric signals detected by the two photoelectric sensors may change. Correspondingly, the horizontal degree of the door body 101 may also change. For example, when the intensity of the photoelectric signals detected by the two photoelectric sensors increases, the horizontal degree of the door body 101 decreases, that is, the degree of tilt of the door body 101 increases. This allows the horizontal degree of the door body 101 in the door-opening object of the movable plate 32 to be measured through the change in the intensity of the photoelectric signals detected by the two photoelectric sensors.

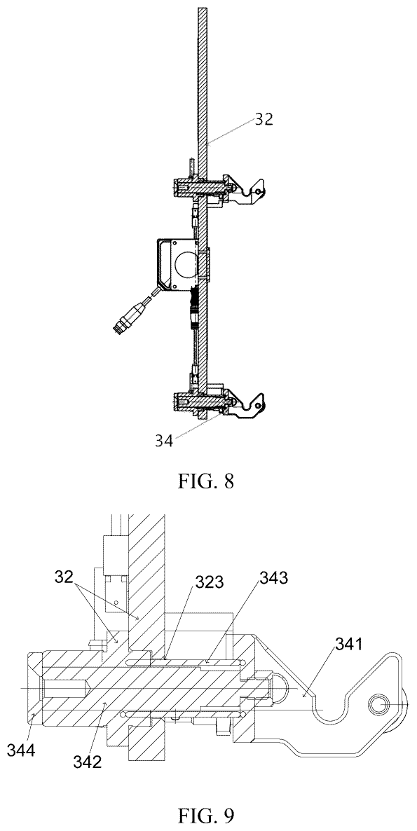

With reference to FIGS. 8 and 9, the door connecting structure 34 includes hooks 341, and the hooks 341 may switch between the open-door position and the closed-door position. For example, the hooks 341 may engage with the connecting shafts 102 on the door body 101 when it is in the open-door position and the closed-door position.

The hooks 341 may include four hooks arranged on the movable plate 32. The four hooks are arranged in pairs, horizontally opposite to each other. Note FIG. 8 focuses on a first pair of hooks 341 and FIG. 9 focuses on a detailed view of one of the hooks 341. After two hooks respectively hook onto two connecting shafts of the door body 101, the door body 101 may be opened or closed by the movement of the movable plate 32 driven by the loading platform lifting mechanism 4 and the traveling mechanism 6, as shown in FIGS. 20 to 22.

Furthermore, among the four hooks, two hooks may form a bottom hook group, and another two hooks may form a top hook group. If the top hook group in the bottom and top hook groups is close to the connecting shaft(s) of the door body 101, the top hook group on the door connecting structure 34 is driven by the driving member 33 to be connected to the door body 101, thereby shortening the movement distance of the movable plate 32 and improving the efficiency of the stacker crane in opening and closing the door body 101.

In another embodiment, the door connecting structure 34 includes a fixture. By clamping the connecting shaft(s) on the door body 101 with the fixture, the door connecting structure 34 may also be connected to the door body 101, and the switching of the door body 101 between the open position and the closed position is achieved.

With reference to FIG. 9, the door connecting structure 34 further includes a guide shaft 342 and an elastic member 343. The movable plate 32 has a guide hole 323;

The guide shaft 342 is movably arranged in the guide hole, at least one of the hooks 341 is connected to the guide shaft 342, and the elastic member 343 abuts between the movable plate 32 and the hook 341.

When the door connecting structure 34 is connected to the door body 101, a movable gap may be formed between the movable plate 32 and the hook 341. Under a condition that the hook 341 hits the door body 101 due to a positional deviation, the guide shaft 342 and the hook 341 may both retreat under the impact force, thereby avoiding a hard collision between the hook 341 and the door body 101, protecting the structural integrity of the hook 341 and the door body 101. At the same time, the elastic member 343, in the form of a spring or a plastic elastomer body, is compressed.

After the hook 341 disengages from the door body 101, the elastic member 343 may restore the hook 341 to its original position as the elastic member 343 returns from deformation, facilitating the reconnection between the hook 341 and the door body 101.

Moreover, FIG. 9 shows the door connecting structure 34 further includes an anti-drop cap 344, and circumferential dimensions of the anti-drop cap 344 and the hook 341 are greater than an aperture of the guide hole;

The hook 341 is connected to a first end of the guide shaft 342. The anti-drop cap 344 is connected to a second end of the guide shaft 342. The hook 341 and the anti-drop cap 344 are located on two sides of the movable plate 32, respectively.

When the hook 341 and the anti-drop cap 344 are connected to both ends of the guide shaft 342, a stable connection between the door connecting structure 34 and the movable plate 32 may be achieved, thereby preventing the guide shaft and the hook 341 from detaching from the movable plate 32.

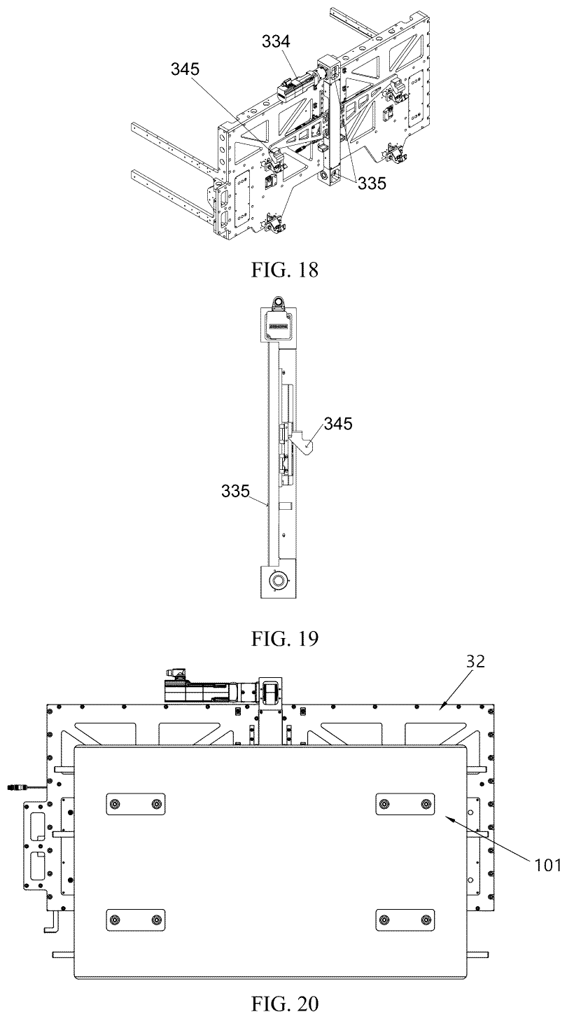

With reference to FIGS. 18 and 19, the door connecting structure 34 includes a pressing block 345. The driving member 33 includes a third driving member 334. The third driving member 334 is configured to drive the pressing block 345 to move in a direction toward the hook 341.

The third driving member 334, in the form of a motor or a pneumatic cylinder, may drive the pressing block 345 to move upward or downward toward or away from the hook 341 through a synchronous belt 335, so as to clamp and fix the connecting shaft 102 on the door body 101 between the hook 341 and the pressing block 345. In this way, the hook 341 and the pressing block 345 form an enclosing structure around the connecting shaft 102 on the door body, ensuring that the hook 341 may successfully hook onto the connecting shaft 102 on the door body 101. At the same time, the movement of the synchronous belt may be guided by the cooperation of a linear rail and a sliding block, ensuring the accuracy of moving upward or downward and positioning of the pressing block 345.

In one embodiment, the door connecting structure 34 includes two pressing blocks 345, which are arranged vertically opposite to the two hooks 341 that are arranged horizontally opposite to each other so as to clamp and fix the two connecting shafts 102 on the door body 101 between the corresponding hooks 341 and the pressing blocks 345, thereby improving the stability of the connection between the door connecting structure 34 and the door body 101 of the facility.

An embodiment of the present disclosure also provides a warehousing system, including a facility and the stacker crane as described;

The facility includes a door body 101. The door connecting structure 34 may be connected to the door body 101 and may switch between the open-door and the closed-door positions.

A warehousing system may include the stacker crane shown in FIGS. 1-22. The stacker crane of the warehousing system may include driving member 33. When driving member 33 drives the movable plate 32 to move, the movable plate 32 may move to a position where the door connecting structure 34 is connected to the door body 101. At the same time, the loading platform lifting mechanism 4 and the traveling mechanism 6 may drive the movable plate 32 and the door body 101 to move together, so that the door body 101 switches between the open position and the closed position. This eliminates the need to provide a structure for opening and closing the door for the facility, improving the convenience of opening and closing the door body 101 and ensuring the efficiency of the structural cooperation between the stacker crane and the facility.

Although some specific embodiments of the present disclosure have been described in detail by way of examples, a person having ordinary skill in the art should understand that the above examples are merely for illustration and are not intended to limit the scope of the present disclosure. A person having ordinary skill in the art should understand that the above embodiments may be modified without departing from the scope and spirit of the present disclosure. The scope of the present disclosure is defined by the appended claims.

What is claimed is:

1. A stacker crane, comprising:
a frame assembly;
a loading platform, the loading platform movably arranged in the frame assembly;
a mobile assembly, the mobile assembly including a bracket, a movable plate and a driving member, the bracket arranged on the loading platform, and the movable plate movably connected to the bracket through the driving member; and
a door connecting structure arranged on the movable plate, wherein the driving member drives the movable plate to move.

2. The stacker crane according to claim 1, wherein the driving member includes a first driving member and a connecting member, the first driving member is arranged on the bracket, an output end of the first driving member is connected to the movable plate through the connecting member,
the first driving member is configured to drive the connecting member and the movable plate to move together along a first direction.

3. The stacker crane according to claim 2, further comprising a first sliding rail arranged on the bracket and a first sliding block arranged on the connecting member, wherein the first sliding block is in sliding fit with the first sliding rail, or
the first sliding block arranged on the bracket and the first sliding rail arranged on the connecting member, wherein the first sliding block is in sliding fit with the first sliding rail.

4. The stacker crane according to claim 2, wherein the driving member includes a second driving member, the second driving member is arranged on the connecting member, an output end of the second driving member is connected to the movable plate,
the second driving member is configured to drive the movable plate to move along a second direction, the second direction being perpendicular to the first direction.

5. The stacker crane according to claim 4, further comprising a second sliding block arranged on the connecting member and the second sliding rail arranged on the movable plate, wherein the second sliding rail is in sliding fit with the second sliding block, or
the second sliding rail arranged on the connecting member and the second sliding block is arranged on the movable plate, wherein the second sliding rail is in sliding fit with the second sliding block.

6. The stacker crane according to claim 1, further comprising two distance-measuring sensors arranged on the movable plate, wherein the two distance-measuring sensors are arranged oppositely.

7. The stacker crane according to claim 1, wherein the door connecting structure includes hooks, the door connecting structure further includes a guide shaft and an elastic member, the movable plate includes a guide hole,
the guide shaft is movably arranged in the guide hole, at least one of the hooks is connected to the guide shaft, and the elastic member abuts between the movable plate and the at least one of the hooks.

8. The stacker crane according to claim 7, wherein the door connecting structure includes an anti-drop cap, and circumferential dimensions of the anti-drop cap and the at least one of the hooks are greater than an aperture of the guide hole,
the at least one of the hooks is connected to a first end of the guide shaft, the anti-drop cap is connected to a second end of the guide shaft, and the at least one of the hooks and the anti-drop cap are located on two sides of the movable plate, respectively.

9. The stacker crane according to claim 7, wherein the door connecting structure includes a pressing block, the driving member includes a third driving member, the third driving member is configured to drive the pressing block to move in a direction toward the at least one of the hooks.

10. A warehousing system, comprising a facility and a stacker crane, the stacker crane, comprising:
a frame assembly;
a loading platform, the loading platform movably arranged in the frame assembly;
a mobile assembly, the mobile assembly including a bracket, a movable plate and a driving member, the bracket arranged on the loading platform, and the movable plate movably connected to the bracket through the driving member; and
a door connecting structure arranged on the movable plate, where the driving member drives the movable plate to move,
wherein the facility includes a door body, the door connecting structure is connected to the door body, and the door connecting structure is configured to switch between an open-door position and a closed-door position.

11. The warehousing system according to claim 10, further comprising a loading platform lifting mechanism, a pulley assembly and a traveling mechanism,
wherein the loading platform lifting mechanism and the traveling mechanism are installed on the frame assembly, the mobile assembly is installed on the loading platform, and the loading platform is connected to the loading platform lifting mechanism through a rope via the pulley assembly.

12. The warehousing system according to claim 10, wherein the driving member includes a first driving member and a connecting member, the first driving member is arranged on the bracket, an output end of the first driving member is connected to the movable plate through the connecting member,
the first driving member is configured to drive the connecting member and the movable plate to move together along a first direction.

13. The warehousing system according to claim 12, wherein the stacker crane further comprises a first sliding rail arranged on the bracket and a first sliding block arranged on the connecting member, wherein the first sliding block is in sliding fit with the first sliding rail, or
the first sliding block arranged on the bracket and the first sliding rail arranged on the connecting member, wherein the first sliding block is in sliding fit with the first sliding rail.

14. The warehousing system according to claim 12, wherein the driving member includes a second driving member, the second driving member is arranged on the connecting member, an output end of the second driving member is connected to the movable plate,
the second driving member is configured to drive the movable plate to move along a second direction, the second direction being perpendicular to the first direction.

15. The warehousing system according to claim 14, wherein the stacker crane further comprises a second sliding block arranged on the connecting member and a second sliding rail arranged on the movable plate, wherein the second sliding rail is in sliding fit with the second sliding block, or
the second sliding rail arranged on the connecting member and the second sliding block arranged on the movable plate, wherein the second sliding rail is in sliding fit with the second sliding block.

16. The warehousing system according to claim 10, wherein the stacker crane further comprises two distance-measuring sensors arranged on the movable plate, wherein the two distance-measuring sensors are arranged oppositely.

17. The warehousing system according to claim 10, wherein the door connecting structure includes hooks, the door connecting structure further includes a guide shaft, and an elastic member, the movable plate includes a guide hole,
the guide shaft is movably arranged in the guide hole, at least one of the hooks is connected to the guide shaft, and the elastic member abuts between the movable plate and the hook.

18. The warehousing system according to claim 17, wherein the door connecting structure includes an anti-drop cap, and circumferential dimensions of the anti-drop cap and the at least one of the hooks are greater than an aperture of the guide hole,
the at least one of the hooks is connected to a first end of the guide shaft, the anti-drop cap is connected to a second end of the guide shaft, and the at least one of the hooks and the anti-drop cap are located on two sides of the movable plate, respectively.

19. The warehousing system according to claim 17, wherein the door connecting structure includes a pressing block, the driving member includes a third driving member, and the third driving member is configured to drive the pressing block to move in a direction toward the at least one of the hooks.

20. The warehousing system according to claim 10, wherein the stacker crane further comprises a loading platform lifting mechanism, a pulley assembly and a traveling mechanism,
wherein the loading platform lifting mechanism and the traveling mechanism installed on the frame assembly, the mobile assembly installed on the loading platform, and the loading platform connected to the loading platform lifting mechanism through a rope via the pulley assembly.
